(19) United States
(12) Patent Application Publication
(10) Pub. No.: US 2007/0203788 A1
(43) Pub. Date: Aug. 30, 2007

(54) Gift giving process and system

(76) Inventors: A. Hamid Andalib, Chattanooga, TN (US); David Allen Barber, Hixson, TN (US); Jeffrey Walker Grine, Chattanooga, TN (US); Brad James Smrcina, Cleveland, TN (US)

Correspondence Address: LUEDEKA, NEELY & GRAHAM, P.C., P O BOX 1871, KNOXVILLE, TN, 37901, US

(21) Appl. No.: 10/934,100

(22) Filed: Sep. 3, 2004

Related U.S. Application Data
(60) Provisional application No. 60/535,934, filed on Jan. 12, 2004.

(51) Int. Cl. G06Q 30/00

(52) U.S. Cl. 705/14

(57) ABSTRACT

The invention provides a method of giving a gift instrument having a value to a recipient. The method comprises (a) ordering the gift instrument from a central processing facility, (b) delivering the gift instrument to the recipient, (c) receiving the gift instrument by the recipient, (d) redeeming the gift instrument by selecting goods or services from a redemption facility, where the goods or services have a value corresponding to the value of the gift instrument, and (e) providing the goods or services to the recipient. The step of ordering the gift instrument may include accessing an Internet web page associated with the central processing facility. The step of delivering the gift instrument may include sending an electronic text message to the recipient's text-compatible cell phone. The electronic text message preferably instructs the recipient to visit a particular Internet web page to receive further information needed to redeem the gift instrument to receive the products or services, such as consumer goods, travel vouchers or debit cards.

This application is a continuation-in-part of provisional application No. 60/535,934, which was filed on Jan. 12, 2004.

### FIELD OF THE INVENTION

The present invention is generally directed to a method of doing business. More particularly, the invention is directed to a method for gift giving, redeeming, and fulfillment and a related system for implementing the method.

### BACKGROUND

Gift giving can be a stressful and arduous process. People tend to spend large amounts of time deciding the type of gift and how to obtain and appropriately present the gift to the recipient for maximum enjoyment of the recipient. Traditionally, gift-givers shop around at malls and other retail stores to find and purchase the appropriate gift. With the advent of the Internet, however, gift-givers can now shop and purchase “on-line,” which can alleviate some of the stress associated with traditional gift giving. However, the chosen gift is often not the receiver's desired or optimum gift. The gift is then sometimes returned (if possible or feasible), or stored away and unused, resulting in a waste of time, resources, and space and often feelings of dissatisfaction with the whole process.

Thus, there is a need for an improved gift giving process whereby the gift giver can more easily select a desired gift from a number of different goods and/or services without the problems and difficulties associated with prior methods, and which creates a more enjoyable, exciting, and effective process for the gift giver and recipient.

### SUMMARY OF THE INVENTION

The above and other needs are met by a method of providing a gift instrument having a value to a recipient. The method comprises (a) ordering the gift instrument from a central processing facility, (b) delivering the gift instrument to the recipient, (c) receiving the gift instrument by the recipient, (d) redeeming the gift instrument by selecting goods or services from a redemption facility, where the goods or services have a value corresponding to the value of the gift instrument, and (e) providing the goods or services to the recipient.

In some preferred embodiments of the invention, the step of ordering the gift instrument further comprises accessing an Internet web page associated with the central processing facility.

In some preferred embodiments, the method includes delivering the gift instrument by sending an electronic text message to the recipient's text-compatible cell phone. The electronic text message preferably instructs the recipient to visit a particular Internet web page to receive further information needed to redeem the gift instrument to receive products or services, such as consumer goods, travel vouchers or debit cards.

### BRIEF DESCRIPTION OF THE DRAWINGS

Aspects of the present invention will become apparent by reference to the detailed description of preferred embodiments when considered in conjunction with the following drawings, which are not to scale, wherein like reference characters designate like or similar elements throughout the several views:

FIG. 1 is a flowchart depicting a gift giving process according to a preferred embodiment of the invention;

FIG. 2 is a flowchart depicting steps of a gift giving process according to a preferred embodiment of the invention;

FIG. 3 is a flowchart depicting an ordering phase of a gift giving process according to a preferred embodiment of the invention;

FIG. 4 is a flowchart depicting a redemption phase of a gift giving process according to a preferred embodiment of the invention;

FIG. 5 is a flowchart depicting a fulfillment phase of a gift giving process according to a preferred embodiment of the invention;

FIG. 6 is a flowchart depicting an example of a gift giving process involving a gift check according to a preferred embodiment of the invention;

FIG. 7 is a flowchart depicting another example of a gift giving process involving a credit card according to a preferred embodiment of the invention; and

FIG. 8 depicts a cellular phone displaying a text message to a recipient of a gift instrument according to a preferred embodiment of the invention.

### DETAILED DESCRIPTION OF THE INVENTION

The process of the present invention preferably utilizes a “gift card” which may be purchased and then redeemed by the purchaser or other recipient for a certain product or service. These “gift cards” are appropriate gifts for virtually any occasion, such as Christmas, birthdays, anniversaries, thank you's, recognition, incentives, and jobs well-done for friends, employees, employers, and the like.

Preferably, the gift card is purchased with an assigned initial dollar value. The gift card's dollar value gives the recipient of the card choices for redeeming its value for many different goods or services. The process preferably utilizes a number of sponsoring entities which offer various goods or services including products from thousands of different nationwide and local merchants, gift certificates, movie tickets, phone cards, debit and credit cards, and gift product catalog items delivered with free shipping. Some example sponsors include restaurants, lounges, bars, night clubs, retail and specialty stores, malls, local merchants, vacation promoters, charities, and theaters. Various vendor discounts, interchange from debit and credit card companies, and commissions on products and services may be an additional benefit to a user of the process. The goods or services are preferably provided to the recipient at no additional cost to the recipient.

Potential users of the gift giving process include consumers in the general public, employers, organizations, and corporations. Consumers generally include members of the general public who order gift cards to give to individuals, family and friends. Employers may include individual business proprietors and companies purchasing gift cards to give to employees as a bonus, award or incentive, or to give to clients or vendors. Organizations may include non-profit groups, civic groups, fund raising groups and many other groups that may use gift cards as gifts or incentives.

It should be appreciated that the phrase “gift card” as used herein refers to a gift instrument which may be a physical card or a nonphysical message, such as an electronic message. For example, a “gift card” may comprise an email message, a voice message or a text message, such as delivered via a phone, handheld computer, pager or other communication device.

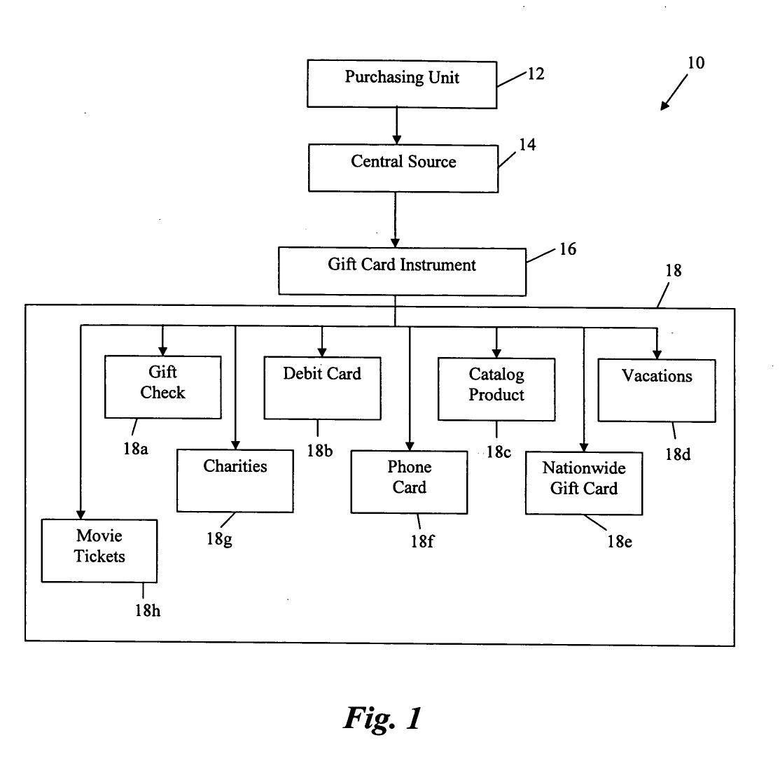

FIG. 1 depicts a gift giving process 10 according to a preferred embodiment of the invention. According to the process 10, a purchasing unit 12, such as an employer, can send a request to a central source 14 for delivery of a gift card 16 to a recipient, such as an employee or a number of employees. Examples of the central source 14 include a central processing facility, an Internet location, and a call center. In one embodiment, the gift card 16 comprises card stock or other form of printed material containing identification information, such as an authorization number, issue date and denomination. The gift card 16 may also contain information about the purchaser and/or the recipient. Additionally, the information on the card may be stored in a central database associated with the central source 14. Preferably, the card 16 is fully transferable to another individual or entity. However, the purchasing unit 12 may request that the card 16 be designated to a particular individual.

The purchasing unit 12 may redeem the card or present the card as a gift, reward or incentive to a recipient for redemption. The card 16 may be redeemed for various goods or services 18. Some examples of redeemable goods and services are depicted in FIG. 1 and include gift checks 18a, gift debit cards 18b, gift catalog products 18c, gift vacations 18d, nationwide gift cards 18e, gift phone cards 18f, charities 18g, and movie tickets 18h.

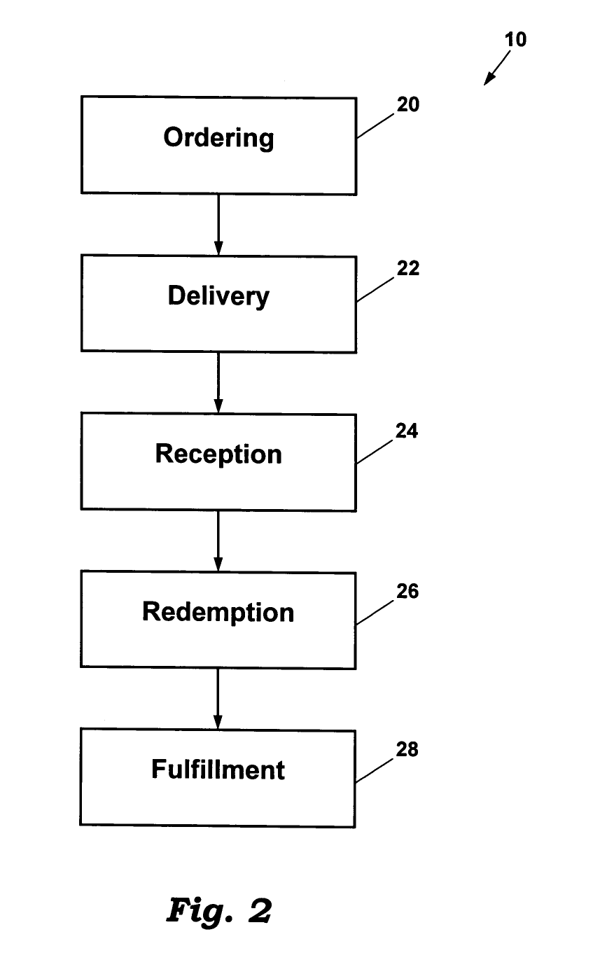

FIG. 2 depicts several steps in a preferred embodiment of the gift giving process 10. The gift giving process 10 most preferably includes an ordering phase 20, a delivery phase 22, a reception phase 24, a redemption phase 26 and a fulfillment phase 28. In some embodiments, some or all of the gifting process 10 is implemented electronically using software and hardware in one or more computers in a networked computer system.

In the ordering phase 20, the purchasing unit 12, such as an employer, purchases a gift card 16 for a recipient, such as an employee of the employer. In most instances, the gift card 16 is ordered having a specific dollar value. In the delivery phase 22, the gift card 16 is delivered to a recipient, either physically or electronically, or the recipient is notified that a gift card has been delivered. In the reception phase 24, the recipient receives the gift card 16, either physically or electronically. In the redemption phase 26, the recipient redeems the gift card 16 for various goods or services. In the fulfillment phase 28, the desired goods or services are provided to the recipient. The ordering, delivery, reception, redemption and fulfillment phases are described in more detail below.

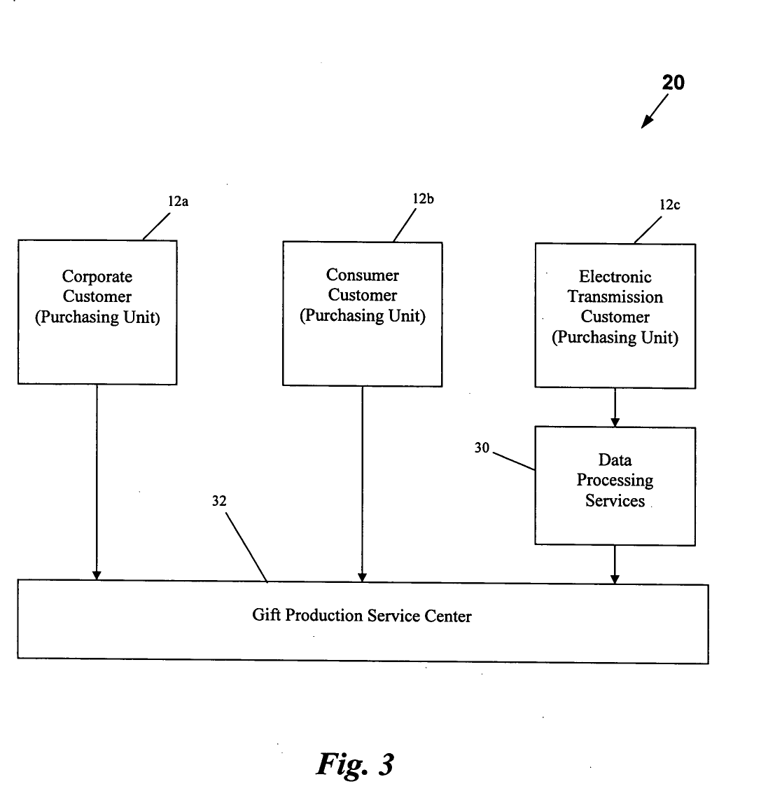

Referring now to FIG. 3, the ordering phase 20 is depicted according to a preferred embodiment of the invention. The ordering phase 20 generally includes the ordering of and payment for the gift card. As described above, a purchasing unit 12 is an entity that orders one or more gift cards. The purchasing unit 12 can place an order for a gift card through various means, such as through the Internet, phone, mail, facsimile, e-mail and face-to-face interaction with a sales representative. Such orders may be placed using order entry systems that are built specifically for national accounts and which contain customized data bases and data processing systems, payroll information tracking and other components specific to individual companies.

FIG. 3 also depicts various examples of purchasing units 12, such as corporate customers 12a, consumer customers 12b, and electronic transmission customers 12c. Electronic transmission customers 12c may include consumers using the Internet, or corporate clients using a customized electronic order entry system. Such electronic order entry systems vary widely in function and application. Some such systems may comprise a custom Internet page for ordering gift cards, while others may involve extensive record keeping capabilities for a company's payroll department.

For electronic transmission customers 12c, a data processing service 30 is preferably provided to electronically process each order. In a preferred embodiment, the data processing service 30 formats data to be used in a central order database. It is most preferred to process complex orders electronically using the data processing service 30. For example, a company may transmit orders as part of a weekly loyalty program through an encrypted data transmission that is converted to a specific data format for processing. As another example, a company may use an order entry system to track what gifts are given to each employee. Such order information may be reported to a company's payroll department to meet a specific set of guidelines for taxation purposes.

As shown in FIG. 3, as part of the ordering phase 20, a purchasing unit 12 requests a gift card for a specific dollar amount for a recipient from the gift production service center 32. When designating a specific recipient, the purchasing unit 12 may provide various types of information to the gift production service center 32 related to the recipient, such as the recipient's name and the preferred mailing address, phone number or email address for receiving the gift card.

In a preferred embodiment, the purchasing unit 12 pays the face value of the card plus a service fee when ordering gift cards. In an alternative embodiment, the ordering process 20 also provides a payment method that changes the ownership of the gift card 16 potentially negating any unclaimed property issues. For example, suppose a number of gift cards 16 are sold to a company for a fee, which is significantly less than the face amount of the gift cards. The fee is paid on the front end and then the face amount is paid later only on those cards that are redeemed. This way the purchasing unit has not bought a gift card having a value, but rather a potential value.

The gifts cards may be purchased individually, in bulk, as tracked information orders, or as an electronic gift card. In a bulk card order, gift cards are sent to the purchasing unit 12 in bulk without a recipient name designation. In a tracked information order, a purchasing unit orders a gift card with the recipient's name and other identification information included. In a bulk order, each card is generated (physically or electronically) with one recipient name, and the order may be shipped directly to the purchasing unit. This recipient may give the card to someone else. With a tracked information order, the card is intended for a specific individual. Electronic gift cards ordered in bulk may be sent to the purchasing unit electronically, such as via the Internet, where the electronic gift cards include identifying information such as authorization code, e-mail address or other electronic tracking information, issue date, and/or denomination amount. After selecting a gift card option, the employer can present the gift card (physically or electronically) to the employee for redemption.

In one embodiment of the delivery process 22, the gift card 16 is individually identified and physically shipped by the service center 32 directly to the recipient using the recipient's information. The gift card may be sent in a variety of methods, such as by mail or courier service. In an alternative embodiment, the gift card information may be communicated to the recipient for redemption, where the gift card information includes identifying information such as authorization code, e-mail address or other electronic tracking information, issue date, and/or denomination amount. The identification information may be communicated by voice message, text message, email, facsimile, or phone call.

In another embodiment of the delivery process 22, an electronic gift card 16 may be delivered electronically to a recipient. The electronic gift card preferably includes identifying information such as authorization code, e-mail address or other electronic tracking information, issue date, redemption methods, redemption options, and/or denomination amount. Electronic gift card delivery methods include e-mail, facsimile and voice message.

In yet another embodiment of the delivery process 22, the electronic gift card is delivered by a text message delivery system. The text message gift card may include identifying information such as authorization code, e-mail address or other electronic tracking information, issue date, redemption methods, redemption options, and/or denomination amount. This information may be delivered via a text message directly to a recipient's text-compatible cell phone, pager, hand-held computer or other communication device.

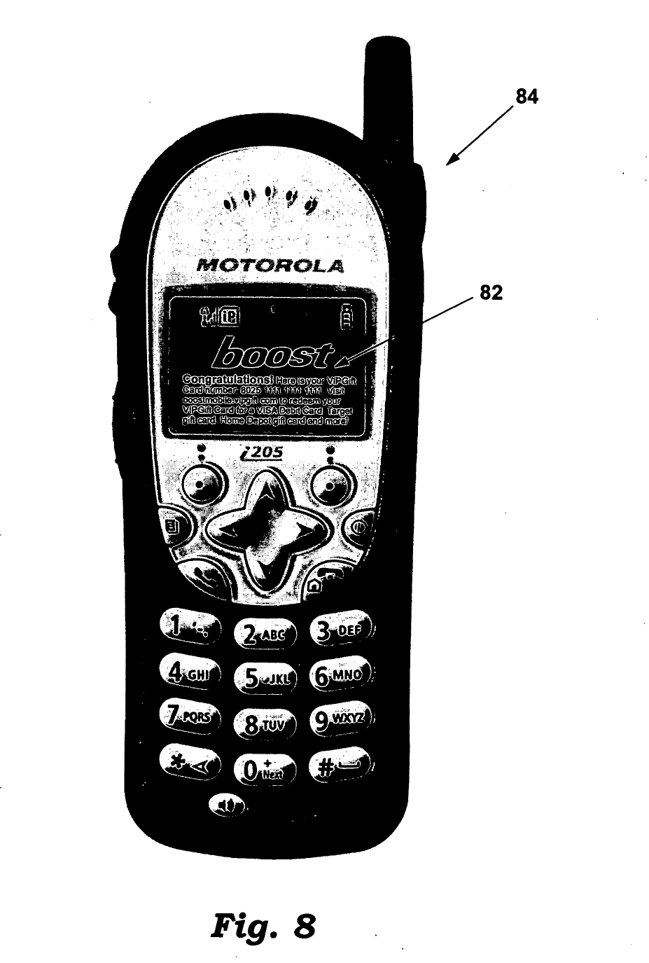

In a preferred embodiment, the recipient of an electronic gift card receives a text message informing the recipient that he or she has been given an electronic gift card. The text message preferably tells the recipient that further information regarding delivery and redemption of the gift card may be found at a particular web site associated with the gift production service center 32. An example of such a text message 82 displayed on a cell phone 84 is depicted in FIG. 8.

Preferably, the text message provides the recipient an authorization number and informs the recipient that further redemption information, such as a redemption code, will be sent to the recipient via email. In this way, two separate information sources must be accessed by the recipient in order to receive all information necessary to receive the gift card. This prevents fraud, since two separate messages, phone text message and email message, would have to be intercepted by a party attempting to fraudulently obtain the gift card.

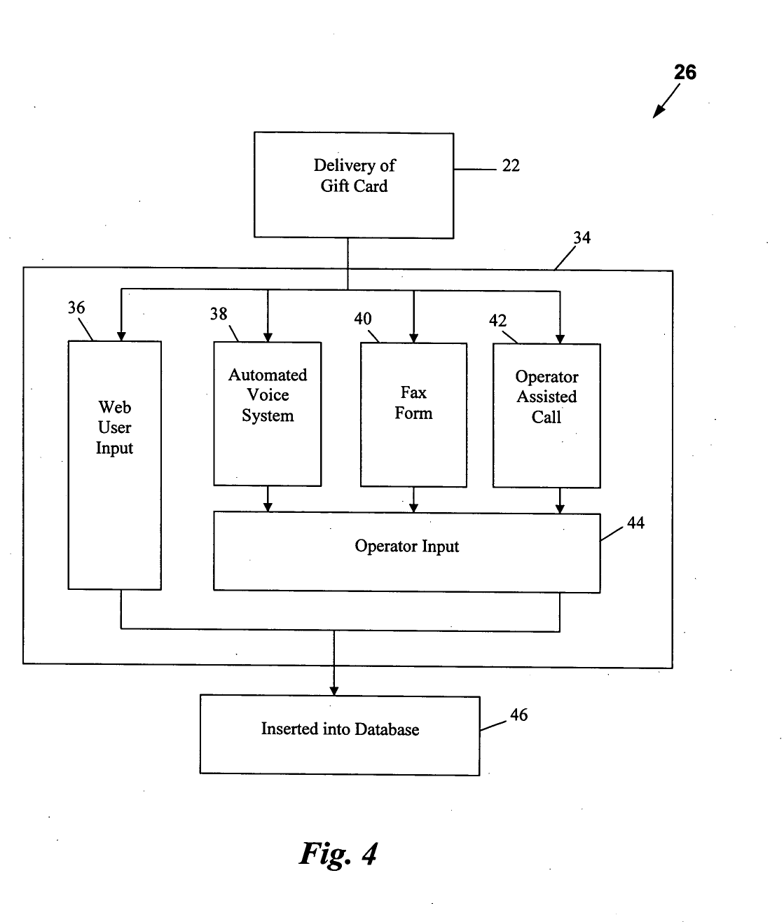

FIG. 4 depicts a preferred embodiment of the redemption process 26. Once the recipient receives the gift card with an authorization number, the redemption process 26 provides various options to the recipient for redeeming the specific dollar amount associated with the gift card. A “redemption event” 34 is the process of comparing a gift card's authorization code with a central database system to verify the gift card's validity. Once verified, a user's gift selection is queued for fulfillment, as described below. Redemption processing mechanisms include on-line or web-based processing with web user inputs 36, automated voice systems 38, facsimiles 40, and operator-assisted telephone calls 42. Preferably, the redemption process 26 relies on user inputs for processing the redemption event. Most preferably, the process 26 utilizes information associated with each card, such as authorization number, issue date, and dollar value. Thus, the information may be manually input, such as with operator assistance 44, or electronically input 36 by the recipient using an electronic device, such as a computer or a web-browsing hand-held computer or phone.

For the electronic or web-based processing option 36, a gift card holder preferably accesses a website having order processing capability. Regardless of the procedure for redeeming a gift card, it is most preferred based on convenience to use the online redemption system 36 as a single point of entry for redemptions. It will be appreciated that there are any number of ways to implement the redemption processing system.

With the exception of the web-based processing option 36, the redemption process 26 preferably uses an operator, whether real-time or automated, to input the card information into a central database 46. For example, a 24 hour, seven day a week automated voice system 38, facsimile form submission 40, or operator-assisted call-in system 42 may be utilized to redeem the gift card for various products and/or services. However redeemed, the gift card and other related redemption information is most preferably entered into the central database 46 for processing and fulfillment.

Each card preferably includes information specific to the recipient and the purchasing unit which is stored in the central database 46. Preferably, each gift card includes a unique identifier, such as identification information in the form of an authorization code, and/or a memory device for verifying and storing the information which is to be transferred to the central database 46, in whole or in part. For example, if the gift card is a physical card, then printed numbers, magnetic stripes, barcodes, and/or smart chips can be used to store the identification information on the gift card. Also, the identification information may be specific to each gift card and include the purchasing unit's name and contact information, the recipient's name, home or business address, e-mail address, employer name, and/or dollar value.

The central database 46 contains the identification information for each gift card delivered from a gift card processing center 32. Preferably, the central processing facility 32 includes the central database 46 and the software and hardware processing capabilities.

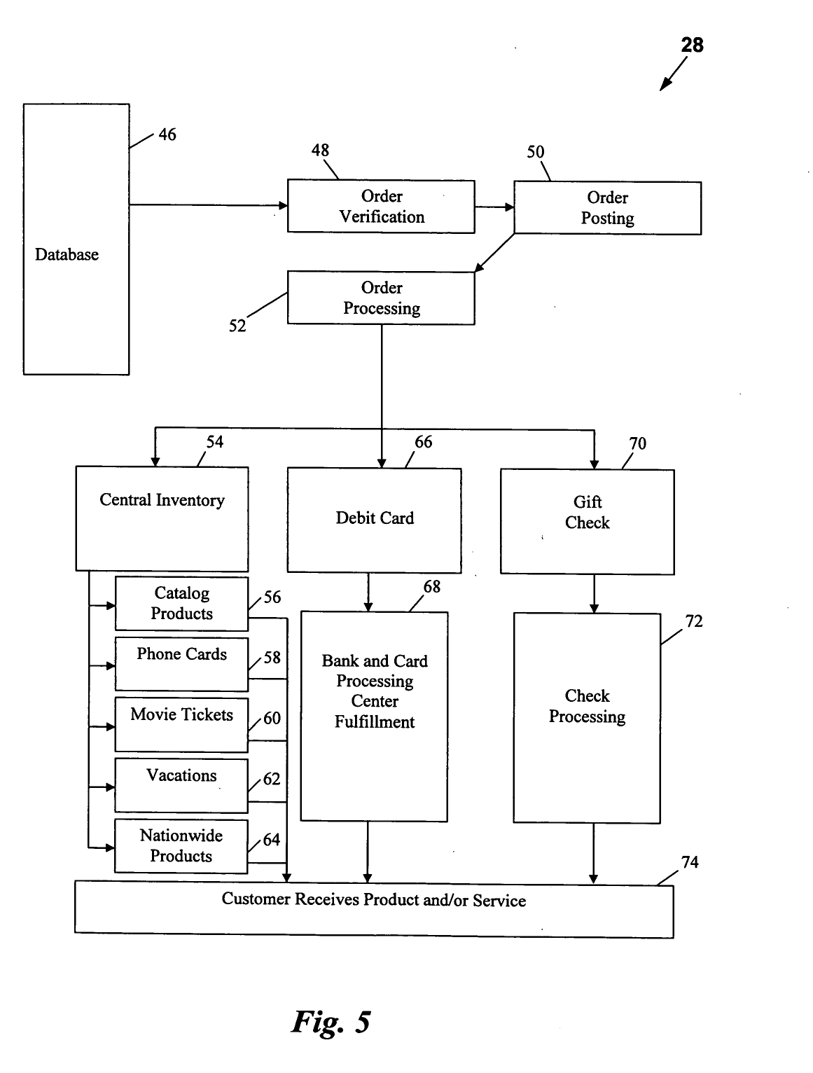

A preferred embodiment of the fulfillment process 28 is depicted in FIG. 5. The fulfillment process 28 begins with a verification process 48 that verifies the order for a specific gift card based on the information stored in the central database 46. For example, the process 48 verifies the legitimacy of the authorization number entered, the dollar amount remaining on the gift card, and the dollar amount used in the redemption action. Most preferably, gift cards older than six months from the issue date are reduced in value by certain fees. The order is then posted 50, wherein the dollar amount of the gift card is reduced by the value of the goods or services ordered.

The posting process 50 generally involves segmenting the order based on the type of fulfillment. That is, orders are preferably separated according to the products or services for which they were redeemed. For example, a person may redeem two $50 cards for a total of $100. Alternatively, the person may redeem four $25 items, such as one gift check to Merchant A, one phone card, one nationwide gift card to Merchant B, and one catalog product. The gift check may be produced internally, the phone card and Nationwide Merchant cards may be fulfilled through inventory and the catalog item may be sent to the third party fulfillment center.

Once posted, the order is processed 52 according to one of several fulfillment options. As described above, fulfillment examples include in-house fulfillment, third party fulfillment, and internal product generation. Preferably, in-house fulfillment includes a central inventory 54 that is physically or electronically linked to the central database 46. The central inventory 54 preferably operates to fulfill catalog products 56, phone cards 58, movie tickets 60, vacation packages 62, and nationwide consumer products 64. Nationwide consumer products 64 are generally provided by national companies by way of gift cards that may be purchased at a discount. These include restaurants, merchants, malls, groceries and online companies. Once redeemed, goods and services are preferably delivered from the central inventory 54 to the recipient.

Third party fulfillment preferably includes physically or electronically transmitting orders to a third party company for fulfillment. Most preferably, third party fulfillment is used in conjunction with catalog products 56 and debit card options 66, where the third party handles all aspects of inventory and shipping of the ordered goods. In the case of a debit card 66, a third party bank or other card processing service 68 handles issuance of the card 66 to the recipient.

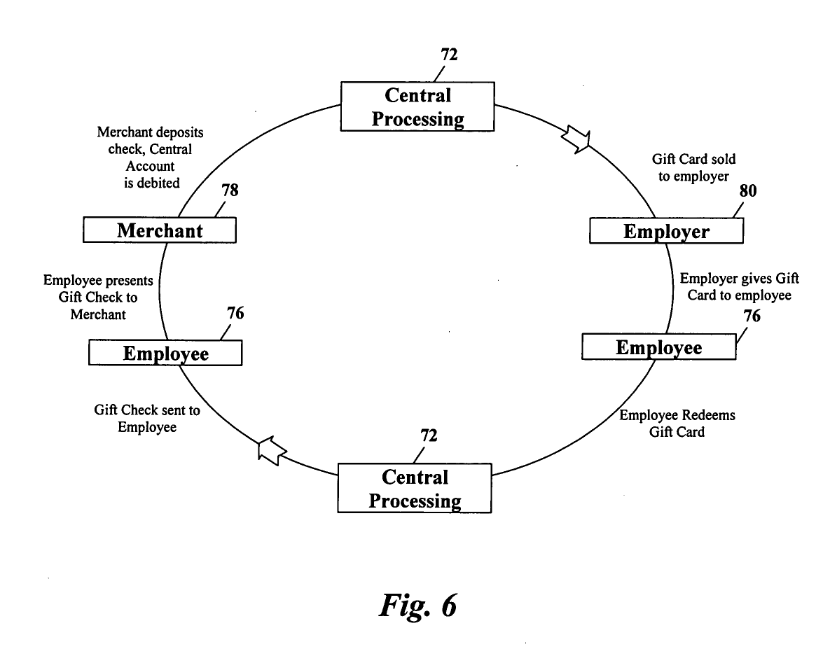

Internal product generation most preferably produces and mails a gift check 70. An example of the gift process for use with a gift check 70 is shown in FIG. 6. The gift check 70 is preferably payable to a selected merchant. Preferably, a check processing center 72 is physically or electronically linked to the central processing facility 32. After processing the gift check 70 at the check processing center 72, the gift check is sent in the mail or by other means to the employee 76. Alternatively, the gift check can be sent electronically to a designated email account or other electronic account, or via text message to the recipient's phone, hand-held computer or pager. Preferably, the gift check is a traditional check, payable to a specified merchant 78, drawn against a reserve account, and delivered to a designated gift card holder to be used as tender for payment. Preferably, each gift check is registered on the date on which it is redeemed by the gift card recipient (the “Check Issue Date”).

Preferably, all gift checks not tendered to a participating merchant for payment within six months of the Check Issue Date expire and become void. To the extent permitted by law, upon expiration of the gift check, its value is reduced by a monthly service charge assessed beginning on the date that is six months from the Check Issue Date and continuing on a monthly basis thereafter until the monthly service charges reduce the gift check value to $0. If a gift check expires, the gift check holder may request re-issuance provided that the gift check holder agrees to pay the fee charged by the bank to stop payment on the original gift check, plus an administrative fee for re-issuance of the gift check. These charges are preferably debited automatically from the original value of the gift check. If the value of a gift check is insufficient to satisfy the cost of the stop payment fee and the administrative re-issuance fee, the gift check will not be reissued.

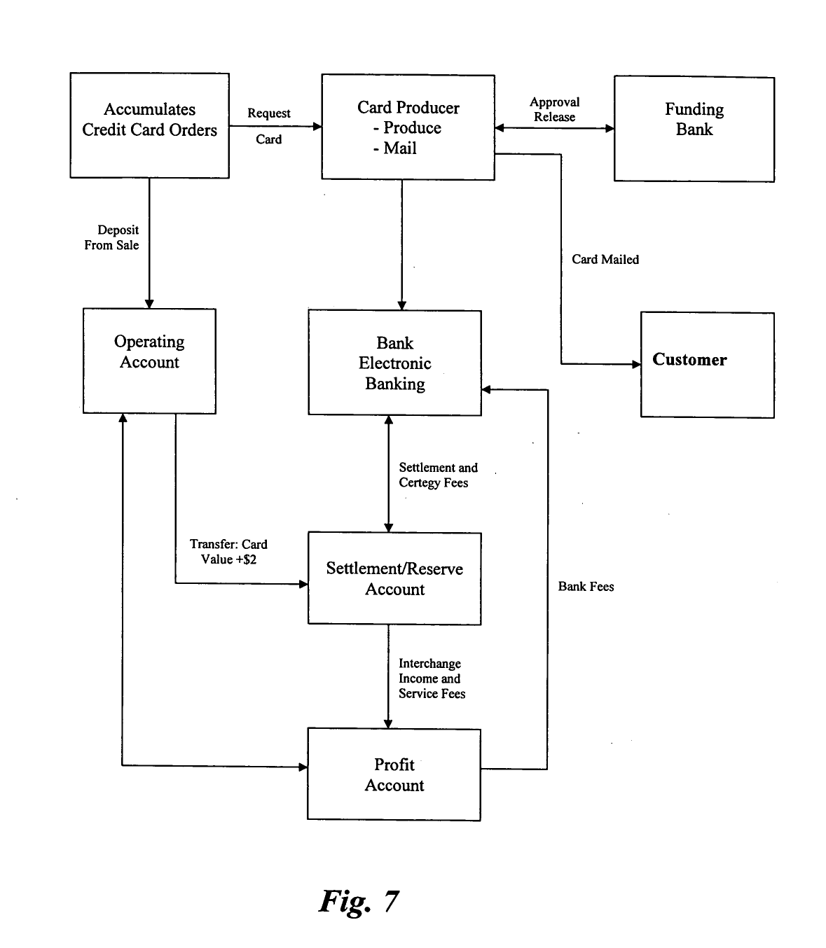

FIG. 7 depicts another aspect of the gift giving process. In this aspect, a debit or credit card can be redeemed in conjunction with a gift card. The debit card is given in exchange for any remaining value of a gift card. Again, it will be appreciated that specific examples or embodiments are given for illustrative purposes, and the invention should not be limited thereto. For example, the debit card is produced through an exclusive use contract with a bank bin number by a third party production facility and may be used for purchases at all designated merchants equipped with a point-of-sale terminal that can process the transaction. The user of the debit card must sign the back of the card before using the card.

Preferably, a one time processing fee is subtracted from the central facility's “Redemption Balance” to issue the debit card. The user can only use a card when there is a balance remaining on the card and only up to the amount left on the card. Purchases and service charges will be deducted from the debit card balance until the value reaches zero. After the amount available on debit card has been exhausted, all transactions will be declined. Transactions that exceed the remaining card balance will also be declined.

If the purchase amount is greater than the amount available on the debit card, the difference can be paid with another form of payment depending on the policy of the merchant. Any transaction attempted for more than the amount available on the debit card will be declined. Therefore, the user should know the amount available on the debit card and inform the merchant to process the transaction in that amount.

A monthly maintenance fee is charged for each month there is a balance remaining on the card. Preferably, the monthly fee is waived for the first six months after the debit card's issue date and will be automatically deducted on the first day of the seventh month from any remaining value on the card until the value reaches zero. If the debit card is inactive for any 12-month period a inactive service fee can be applied.

If the debit card is used for a transaction in a foreign currency amount, the transaction will be converted to U.S. Dollars in accordance with applicable operating regulations for International transactions. Currently, those regulations provide that the exchange rate will be either a government mandated rate or the wholesale market rate in effect one day prior to the transaction processing date, increased by one percent (1%).

It is contemplated, and will be apparent to those skilled in the art from the preceding description and the accompanying drawings that modifications and/or changes may be made in the embodiments of the invention. Accordingly, it is expressly intended that the foregoing description and the accompanying drawings are illustrative of preferred embodiments only, not limiting thereto, and that the true spirit and scope of the present invention be determined by reference to the appended claims.

What is claimed is:

1. A method of providing a gift instrument having a value to a recipient comprising:
(a) ordering the gift instrument from a central processing facility;
(b) delivering the gift instrument to the recipient;
(c) receiving the gift instrument by the recipient;
(d) redeeming the gift instrument by selecting at least one good or service from a redemption facility, the at least one good or service having a value corresponding to the value of the gift instrument; and
(e) providing the at least one good or service to the recipient.

2. The method of claim 1, wherein step (a) further comprises communicating with the central processing facility through a global computer network to order the gift instrument.

3. The method of claim 2, wherein step (a) further comprises accessing an Internet web page associated with the central processing facility to order the gift instrument.

4. The method of claim 1, wherein step (a) further comprises communicating with the central processing facility by telephone to order the gift instrument.

5. The method of claim 1, wherein step (b) further comprises delivering the gift instrument by email, and step (c) further comprises receiving the gift instrument by email.

6. The method of claim 1, wherein step (b) further comprises delivering the gift instrument by sending an electronic text message, and step (c) further comprises receiving the gift instrument by receiving an electronic text message.

7. The method of claim 6, wherein step (c) further comprises receiving first authorization information via the electronic text message, and receiving second authorization information via an email message, where the first and second authorization information are required to redeem the gift instrument.

8. The method of claim 6, wherein step (b) further comprises delivering the gift instrument by sending the electronic text message to a cellular device.

9. The method of claim 6, wherein step (c) further comprises receiving instructions in the electronic text message required to access an Internet web page which provides further instructions required to redeem the gift instrument.

10. The method of claim 1, wherein step (d) further comprises redeeming the gift instrument by selecting one or more consumer goods.

11. The method of claim 1, wherein step (d) further comprises redeeming the gift instrument by selecting one or more charities to receive a contribution corresponding to the value of the gift instrument.

12. The method of claim 1, wherein step (d) further comprises redeeming the gift instrument by selecting one or more travel vouchers.

13. The method of claim 1, wherein step (d) further comprises redeeming the gift instrument by selecting one or more debit cards.

14. A method of providing a gift instrument having a value to a recipient comprising:
(a) ordering the gift instrument from a central processing facility;
(b) delivering the gift instrument by sending an electronic text message to the recipient;
(c) receiving the gift instrument by receiving the electronic text message, where the electronic text message includes instructions for accessing an Internet web page;
(d) accessing the Internet web page which provides further instructions required to redeem the gift instrument;
(e) redeeming the gift instrument by following instructions provided on the Internet web page; and
(f) selecting at least one good or service from a redemption facility, the at least one good or service having a value corresponding to the value of the gift instrument.

15. The method of claim 14, wherein step (a) further comprises accessing an Internet web page associated with the central processing facility to order the gift instrument.

16. The method of claim 14, wherein step (f) further comprises selecting one or more consumer goods.

17. The method of claim 14, wherein step (f) further comprises selecting one or more travel vouchers.

18. The method of claim 14, wherein step (f) further comprises selecting one or more debit cards.

19. A method of giving a gift comprising:
(a) purchasing at least one initial gift instrument from a central processing facility, the initial gift instrument redeemable for at least one merchant gift card;
(b) delivering the at least one initial gift instrument to a first recipient;
(c) redeeming the at least one initial gift instrument by selecting at least one merchant gift card from a redemption center; and
(d) providing the at least one merchant gift card to a second recipient.

20. The method of claim 19 wherein the first recipient and the second recipient are the same entity.

21. The method of claim 19, wherein step (b) further comprises delivering the at least one initial gift instrument via a first electronic text message.

22. The method of claim 19, wherein step (d) further comprises providing the at least one merchant gift card via a second electronic text message.
